(19) United States
(12) Patent Application Publication
(10) Pub. No.: US 2017/0144601 A1
(43) Pub. Date: May 25, 2017

(54) LATERAL-VIEW MIRROR FOR A VEHICLE

(71) Applicants: Lowell Martinson, Phoenix, AZ (US); Charon McNabb, West Bloomfield, MI (US); Barry Hutzel, Holland, MI (US); Steve Brangwyn, Lansing, MI (US)

(72) Inventors: Lowell Martinson, Phoenix, AZ (US); Charon McNabb, West Bloomfield, MI (US); Barry Hutzel, Holland, MI (US); Steve Brangwyn, Lansing, MI (US)

(21) Appl. No.: 15/361,316

(22) Filed: Nov. 25, 2016

Related U.S. Application Data
(60) Provisional application No. 62/259,744, filed on Nov. 25, 2015.

(51) Int. Cl. B60R 1/00; B60Q 1/26; B60K 35/00; B60Q 3/51; B60Q 3/20; B60R 1/12; B60Q 1/44

(52) U.S. Cl. CPC B60R 1/007; B60R 1/1207; B60R 1/12; B60Q 1/268; B60Q 1/44; B60Q 3/51; B60Q 3/20; B60K 35/00; B60R 2001/1292; B60R 2001/1253; B60R 2300/8026; B60R 2300/806; B60R 2300/8013; B60R 2300/8033; B60K 2350/106; B60K 2350/1088; B60K 2350/2013; H04N 7/183

(57) ABSTRACT

A lateral-view mirror assembly comprising a housing having a first lateral-view mirror and a second lateral-view mirror coupled to a rear portion of a vehicle to provide a driver of a vehicle with the ability to view objects positioned lateral to a rear portion of the vehicle by looking at a reflection of the objects reflected from the first and second lateral-view mirrors to the rear-view mirror to the driver. The lateral-view mirror assembly is helpful when backing out of a parking space and also when changing lanes and is located adjacent a ceiling of the vehicle in order to function properly even when a passenger is seated below the lateral-view mirror assembly.

### CROSS REFERENCE TO RELATED APPLICATION[S]

This application claims priority to U.S. Provisional Patent Application entitled “LATERAL-VIEW MIRROR FOR A VEHICLE,” Ser. No. 62/259,744, filed Nov. 25, 2015, now pending, the disclosure of which is hereby incorporated entirely herein by reference.

### BACKGROUND OF THE INVENTION

### Technical Field

This invention relates generally to mirrors for vehicles and, more specifically, to a lateral-view mirror assembly coupled to a rear portion of a vehicle to allow a driver to view objects positioned lateral to the rear portion of the vehicle.

### State of the Art

Driving a car or other vehicle safely requires the driver to constantly be able to see other vehicles, objects and pedestrians. This is often difficult since a car has many blind-spots, and the driver generally is facing forward with limited ability to turn around and view surrounding areas. One situation where a driver's limited field of vision presents an especially acute problem is when pulling out of a parking spot. When a driver needs to back out of a parking space in which he or she is parked face-forward between two other vehicles, especially when those vehicles are large in size, the driver has no ability to see laterally to either side of the rear portion of his or her vehicle to determine if there are pedestrians or other vehicles about to cross into his or her path. Often, most drivers in this situation simply back out slowly in an attempt to alert pedestrians and other cars of the vehicle's presence. It is often the case that pedestrians walking through a parking lot simply do not see a car as it backs out. The same is the case for another vehicle or a bike which might be passing quickly behind the driver's vehicle as he or she backs out. In all of these instances, it is the parked vehicle's driver who is responsible for insuring that his or her car does not strike a pedestrian or vehicle. In order to be sure that a pedestrian or vehicle is not approaching, the driver must be able to see laterally from a rear portion of the driver's vehicle.

Thus, a need existed for a lateral-view mirror assembly coupled to a rear portion of a vehicle to allow a driver to view people, vehicles, and other objects positioned lateral to the rear portion of the vehicle.

### SUMMARY OF THE INVENTION

The present invention relates to a lateral-view mirror assembly coupled to a rear portion of a vehicle to allow a driver to view objects positioned lateral to the rear portion of the vehicle. This can be accomplished, in some embodiments, by looking at a reflection of the objects from the lateral-view mirror assembly positioned in a line of sight with a rear-view mirror of the vehicle.

Embodiments of the present invention include a lateral-view mirror assembly for a vehicle. The lateral-view assembly includes a housing coupled to a rear portion of a vehicle, wherein the housing is located at a substantially center portion of an interior surface-of a rear window and adjacent a ceiling of the vehicle to locate the housing above a head of a passenger seated below the housing; a first lateral-view mirror coupled to the housing, the first lateral-view mirror being positioned in a line of sight with a rear-view mirror of the vehicle to allow a driver to view objects positioned lateral to a passenger's side of the rear portion of said vehicle by looking at a reflection of the objects reflected from the first lateral-view mirror to the rear-view mirror to the driver; and a second lateral-view mirror coupled to the housing, the second lateral-view mirror being positioned in a line of sight with the rear-view mirror of the vehicle to allow the driver to view objects positioned lateral to the driver's side of the rear portion of the vehicle by looking at a reflection of the objects reflected from the second lateral-view mirror to the rear-view mirror to said driver.

Another embodiment may include a lateral-view mirror assembly for a vehicle comprising: a housing moveably coupled to an adjustment device, wherein the adjustment device is coupled to a rear portion of a vehicle to locate the housing at a substantially center portion of an interior surface-of a rear window; a first lateral-view mirror coupled to the housing, the first lateral-view mirror being positioned in a line of sight with a rear-view mirror of the vehicle to allow a driver to view objects positioned lateral to a passenger's side of the rear portion of said vehicle by looking at a reflection of the objects reflected from the first lateral-view mirror to the rear-view mirror to the driver; and a second lateral-view mirror coupled to the housing, the second lateral-view mirror being positioned in a line of sight with the rear-view mirror of the vehicle to allow the driver to view objects positioned lateral to the driver's side of the rear portion of the vehicle by looking at a reflection of the objects reflected from the second lateral-view mirror to the rear-view mirror to said driver, wherein: the adjustment device operates to adjust an angle of the housing with respect to the rear window to adjust the viewing angle of the first lateral-view mirror and the second lateral view mirror.

Yet another embodiment may include a method of using a lateral-view mirror assembly for a vehicle. The method may comprise coupling the lateral-view mirror assembly to a rear portion of a vehicle to locate the housing at a substantially center portion of an interior surface-of a rear window; adjusting an angle of the lateral-view mirror assembly with respect to the rear window; using a first lateral-view mirror coupled to the housing, the first lateral-view mirror being positioned in a line of sight with a rear-view mirror of the vehicle to view objects positioned lateral to a passenger's side of the rear portion of said vehicle by looking at a reflection of the objects reflected from the first lateral-view mirror to the rear-view mirror to the driver; and using a second lateral-view mirror coupled to the housing, the second lateral-view mirror being positioned in a line of sight with the rear-view mirror of the vehicle, to view objects positioned lateral to the driver's side of the rear portion of the vehicle by looking at a reflection of the objects reflected from the second lateral-view mirror to the rear-view mirror to said driver.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a lateral-view mirror assembly of the present invention, showing the line of sight between the rear view mirror and the lateral-view mirror assembly;

FIG. 2 is a perspective view of a lateral-view mirror assembly coupled to a back portion of a vehicle, in accordance with embodiments;

FIG. 3 is a perspective view of a lateral-view mirror assembly with interior lights and a storage compartment coupled to a back portion of a vehicle, in accordance with embodiments;

FIG. 4 is a perspective view of a lateral-view mirror assembly with brake lights and a camera coupled to a back portion of a vehicle, in accordance with embodiments;

FIG. 5 is a perspective view of a lateral-view mirror assembly coupled to a back portion of a vehicle showing a reflected image, in accordance with embodiments;

FIG. 6 is front view of a lateral-view mirror assembly coupled to a back portion of a vehicle showing a reflected image, in accordance with embodiments;

FIG. 7 is a top view of a vehicle using the lateral-view mirror assembly to view pedestrians and another vehicle while backing out of a straight parking space.

FIG. 8 is a top view of a vehicle using the lateral-view mirror assembly showing a driver using the line of sight between the rear view mirror and the lateral-view mirror assembly;

FIG. 9 is a front view of the lateral-view mirror assembly shown coupled to a center portion of an interior surface of the rear window of a vehicle;

FIG. 10 is a perspective view of a lateral-view mirror assembly being used while changing lanes;

FIG. 11 is a top view of a lateral-view mirror assembly being used while changing lanes; and

FIG. 12 is a perspective view of a lateral-view mirror assembly with an electronic display and a warning system.

FIG. 13 is a perspective view of a lateral-view mirror assembly with a structural pivot and vehicle mount plate.

FIG. 14 is a side view of a lateral-view mirror assembly with a structural pivot and vehicle mount plate.

FIG. 15 is a perspective view of a lateral-view mirror assembly with a structural pivot and vehicle mount plate in a rotated position.

### DETAILED DESCRIPTION OF EMBODIMENTS OF THE INVENTION

As discussed above, embodiments of the present invention relate to a lateral-view mirror assembly coupled to a rear portion of a vehicle to allow a driver to view objects positioned lateral to the rear portion of the vehicle.

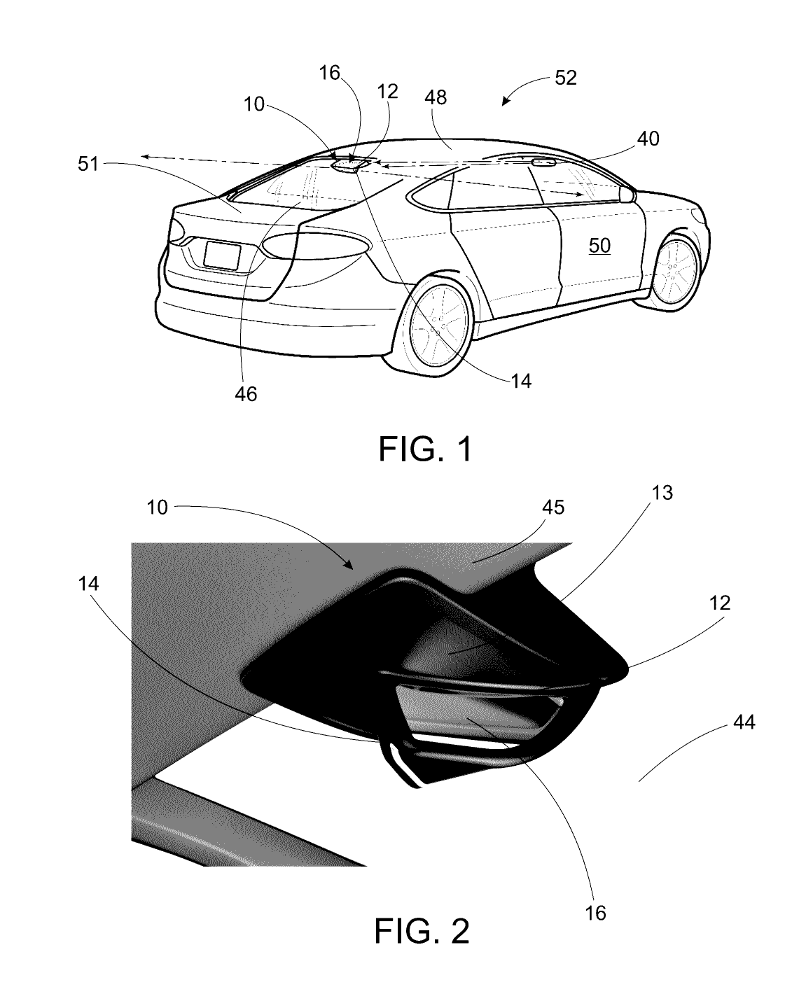

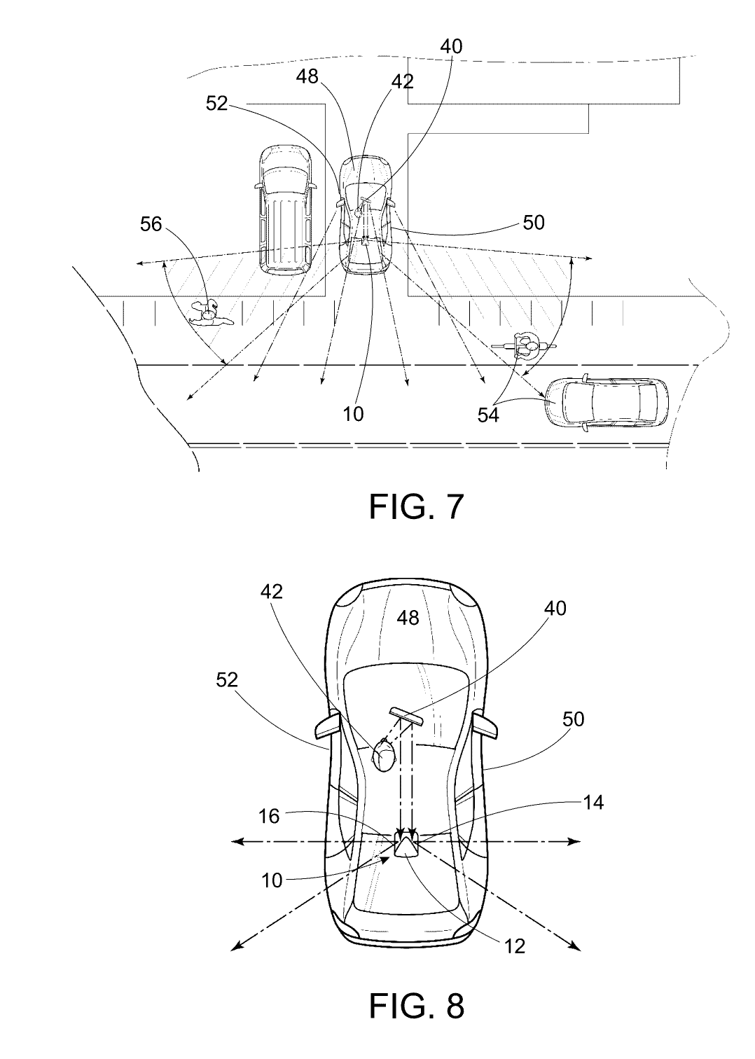

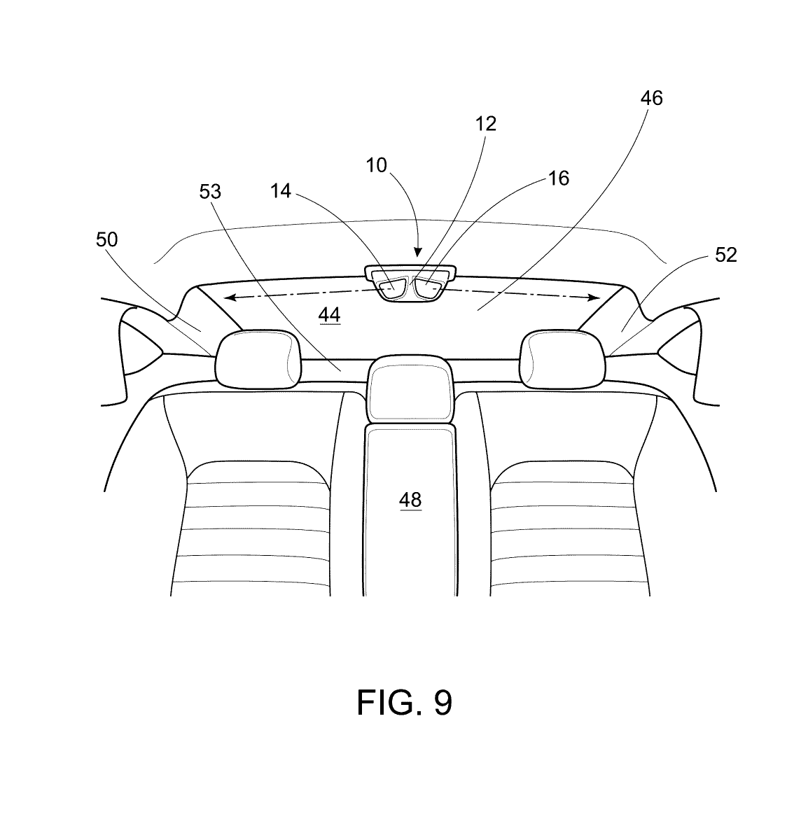

In FIG. 1, a lateral-view mirror assembly 10 is shown in a vehicle 48. The housing 12 is shown coupled to a center portion 46 of the inner surface of the rear window 44 (see FIG. 9) of the vehicle 48. The first lateral-view mirror 14 is coupled to the housing 12 and is positioned in line of sight with the rear-view mirror 40. The first lateral-view mirror 14 is dimensioned to allow a driver 42 (see FIG. 8) to view objects 54 (see FIG. 7) positioned lateral to a passenger's side 50 of a rear portion 51 of the vehicle 48 by reflecting the objects 54 from the first lateral-view mirror 14 to the rear-view mirror 40 to the driver 42.

The second lateral-view mirror 16 is also coupled to the housing 12 and is positioned in light of sight with the rear-view mirror 40. The second lateral-view mirror 16 is dimensioned to allow the driver 42 to view objects 56 (see FIG. 7) positioned lateral to a driver's side 52 of the rear portion 51 of the vehicle 48 by reflecting the objects 56 from the second lateral-view mirror 16 to the rear-view mirror 40 to the driver 42.

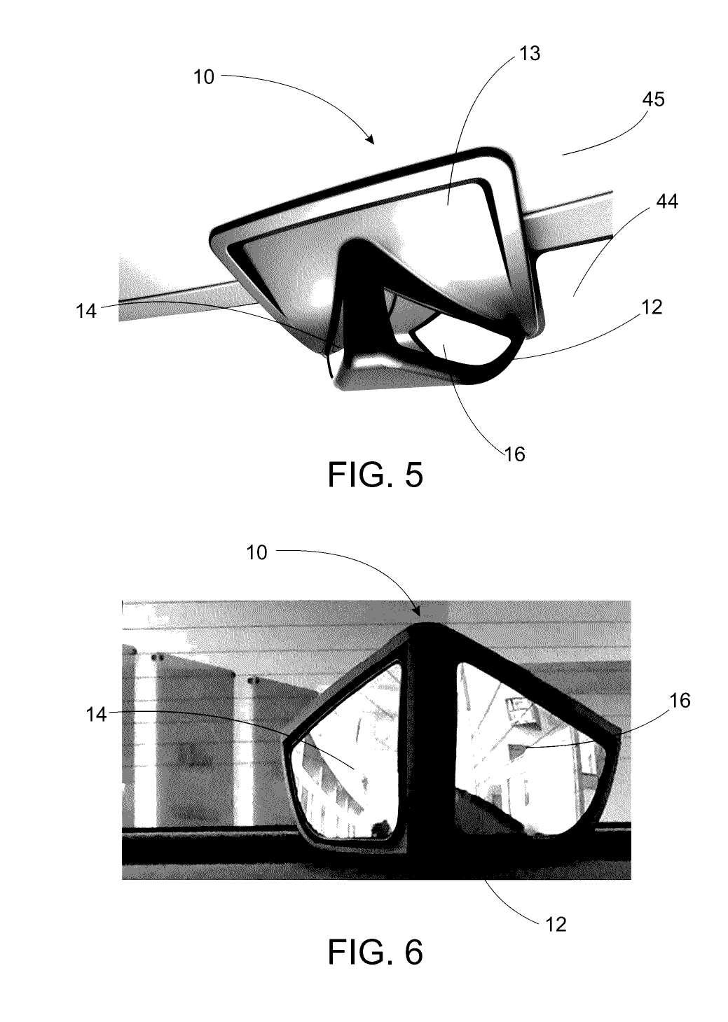

According to embodiments, FIGS. 2 and 5-6 depicts a lateral-view mirror assembly 10. The lateral-view mirror assembly 10 may include housing 12 having a base 13, a first lateral-view mirror 14, and a second lateral-view mirror 16. The base 13 of the lateral-view mirror assembly 10 may be coupled to the rear window 44 adjacent the ceiling 45 of the vehicle 48; coupled to the ceiling 45 of the vehicle 48; or a combination of coupling to the rear window 44 and the ceiling 45 of the vehicle 48. Locating the lateral-view mirror assembly 10 adjacent to the ceiling of the vehicle 48 provides the drive a clear view of the lateral-view mirror assembly 10 even when a passenger is seated directly below the lateral-view mirror. Further, as can be seen in the first lateral view mirror 14 and the second lateral-view mirror 16, objects lateral to a rear portion of the vehicle 48 are reflected.

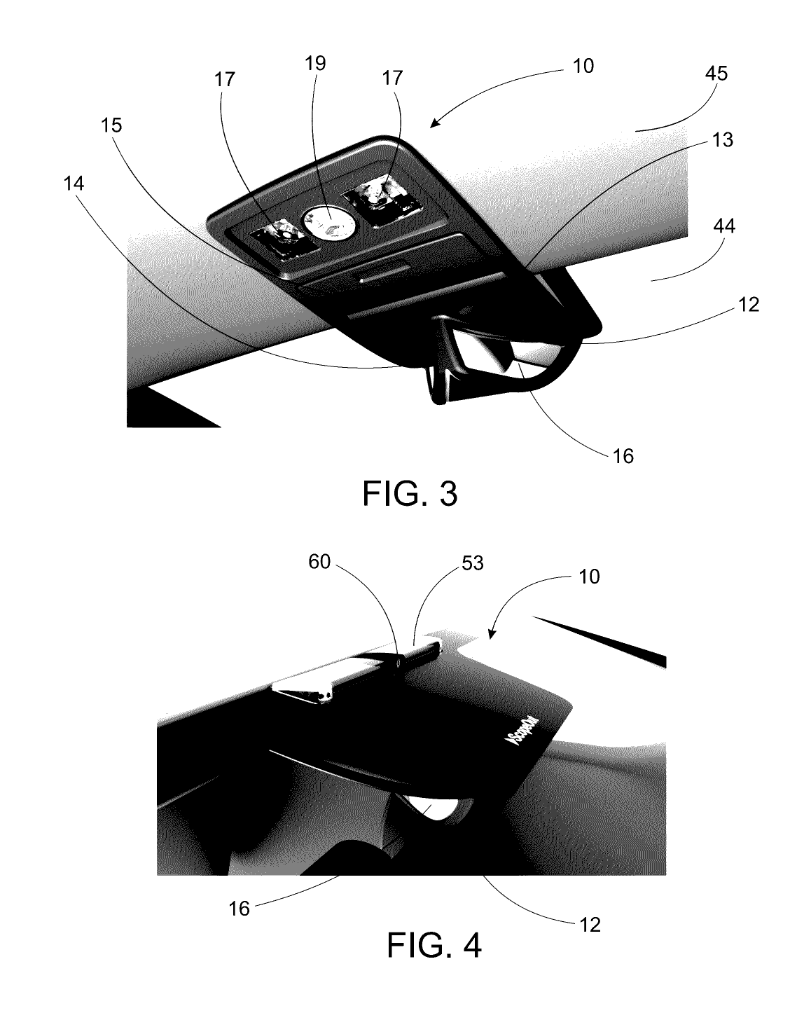

Another embodiment, as depicted in FIG. 3, includes a lateral-view mirror assembly 10 having a housing 12, a base 13, a first-lateral view mirror 14, a second lateral-view mirror 16, a compartment 15, reading lights 17 and a center dome light 19. The base 13 of the lateral-view mirror assembly 10 may be coupled to the rear window 44 adjacent the ceiling 45 of the vehicle 48; coupled to the ceiling 45 of the vehicle 48; or a combination of coupling to the rear window 44 and the ceiling 45 of the vehicle 48. The reading lights 17 may be accessed by rear passengers in order to view a book or other activity without creating a blinding light to the driver. The center dome light 19 may function as a typical dome light to provide light when doors are open and when a vehicle is turned off. Or it may be manually turned on to provide brighter light within the vehicle. The compartment 15 may be utilized to hold small items, such as, but not limited to sunglasses and the like.

Referring again to the drawings, FIG. 4 depicts another embodiment of a lateral-view mirror assembly 10. The lateral-view mirror assembly may include a housing 12, a first lateral-view mirror 14 and a second lateral-view mirror 16. The lateral-view mirror assembly 10 may further include an integral brake light 53. The brake light 53 operates as a typical brake light. In embodiments, the lateral-view mirror 10 may also include a camera 60. The camera 60 may be a back-up camera that can be utilized to view objects directly behind the vehicle. Accordingly, in embodiments with the camera 60, a driver could have the ability to view objects lateral to a rear portion of the vehicle 48 and objects directly behind the vehicle 48.

In some embodiments, brake lights 53 may be vehicle rear lighting 53. This can provide additional lighting to the rear of the vehicle 48. This rear lighting 53 may operate to light the ground directly behind the vehicle 48, thereby improving visibility and backing up capability of the driver using a back-up camera, such as camera 60. In some embodiments, the rear lighting 53 provides light behind and lateral to each side of the vehicle. This can be done during backing operations. Additionally, rear lighting 53 may operate as rear auxiliary lighting that illuminates the side and rear of the vehicle with automatic or manual activation providing added comfort and convenience. In other embodiments, the rear lighting 53 may include a stylized lighting to provide a custom image, logo or the like projected on the ground. In further embodiments, the rear lighting may be a stylized lighting to provide aesthetic accents to the vehicle 48, and to provide additional visibility, like running taillights.

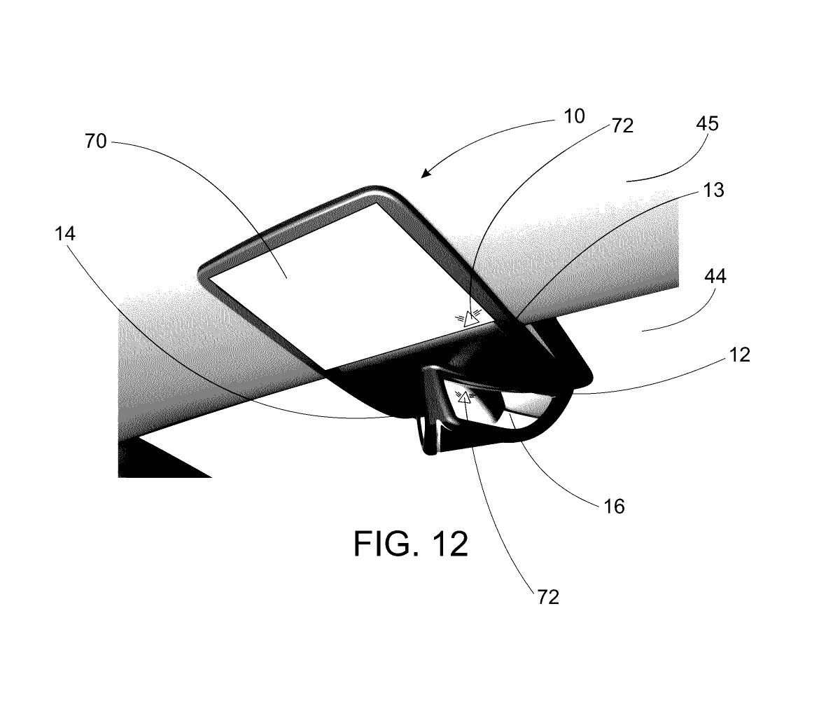

Referring to FIG. 12, in embodiments with camera 60, the housing 12 may also include an electronic display 70. The electronic display 70 may be electrically connected to the camera 60, wherein the electronic display 70 shows what is being captured by the camera 60 in order to aid in backing operations of the vehicle 48. Further, in some embodiments, the electronic display 70 may be display a flipped image so that the image is positioned correctly as the driver views a reflection of the display in the rear view mirror 40. Further still, the electronic display 70 may operate in vehicle 48, even if the vehicle is not reversing. For example and without limitation, the electronic display 70 may operate to show the driver an image from an interior camera, such as one to view a baby in the rear seat of the vehicle, or a side camera of the car to check blind spots. The display being located on the housing 12 is therefore positioned above the head of a passenger sitting below the lateral-view mirror assembly 10.

Additionally, the lateral-view mirror assembly 10 may include proximity sensors external to the vehicle. These sensors sense the location of foreign objects, such as cars, people, animals and the like within a certain proximity of the vehicle. The lateral-view mirror assembly 10, may include icons 72 that can be displayed or lit up on the display 70, on the mirror 14 or 16, and further may be displayed on the housing 12, wherein the driver may view the icon as a visual alert of an object that should be avoided during backing operations. In some embodiments, the icon 72 may be used during driving operation of the vehicle for such notifications during lane changes and the like.

FIG. 7 and FIG. 8 show the lateral-view mirror assembly 10 in use with a vehicle 48. The first lateral-view mirror 14 allows the driver 42 to view objects 54 positioned lateral to the passenger's side 50 of a rear portion 51 of the vehicle 48 by reflecting the objects 54 from the first lateral-view mirror 14 to the rear-view mirror 40 to the driver 42. The second lateral-view mirror 16 allows the driver 42 to view objects 56 positioned lateral to the driver's side 52 of the rear portion 51 of the vehicle 48 by reflecting the objects 56 from the second lateral-view mirror 16 to the rear-view mirror 40 to the driver 42.

In embodiments, the lateral-view mirror assembly 10 may be adjustable and may have a remote controlled system comprising a remote control proximate the driver's side 52 of the vehicle 48 and at least one power actuation device coupled to the housing 12 for adjusting the first lateral-view mirror 14 and the second lateral-view mirror 16 relative to the rear portion 40 of the vehicle 48 when the remote control transmits an actuation signal to the at least one actuation device. Further preferably, the remote controlled system will be programmable with at least one preset position for the first lateral-view mirror 14 and/or the second lateral-view mirror 16. The remote controlled system may be programmed according to a specific driver's preferences and/or may be programmed according to the type of parking space that a driver 42 is pulling out of, i.e. straight (as shown in FIG. 7), angled, or parallel parking. It should be clearly understood, however, that substantial benefit may be derived from the lateral-view mirrors 14, 16 being manually adjustable.

FIG. 9 shows the lateral-view mirror assembly 10 coupled to a center portion 46 of an interior surface of the rear window 44 of the vehicle 48. The lateral-view mirror assembly 10 is shown coupled adjacent a ceiling 45. Vehicles are more commonly locating a brake light in this location and it is understood that substantial benefit may be derived from the brake light 53 being integral to the lateral-view mirror assembly 10, as shown in FIG. 4.

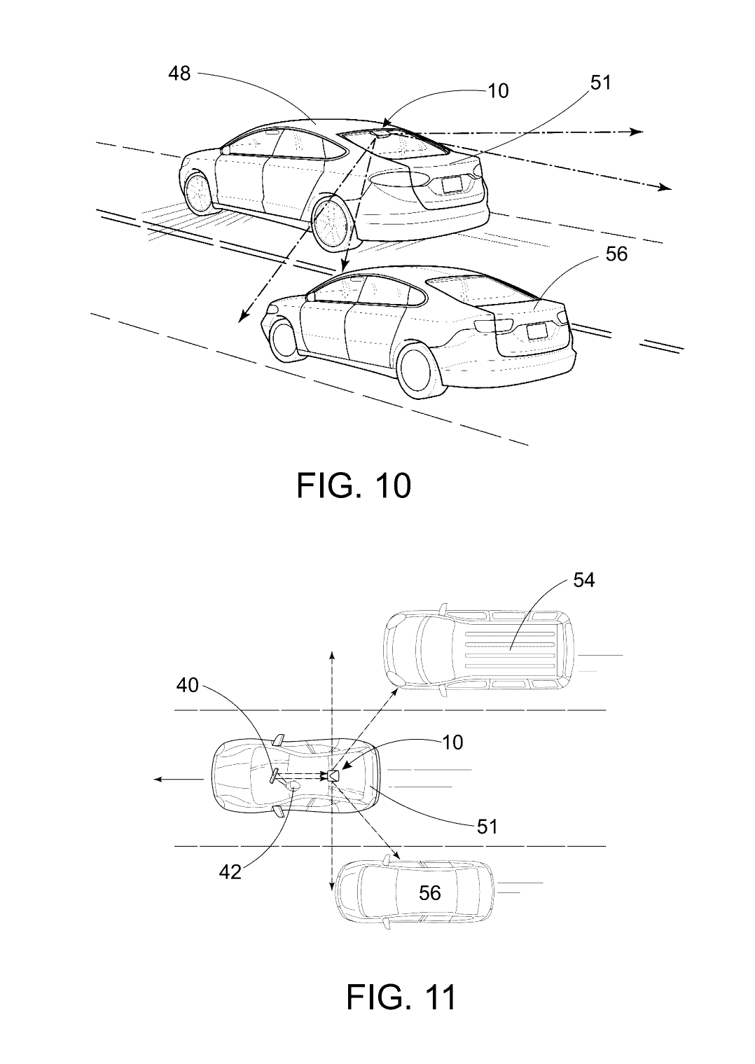

FIGS. 10 and 11 show the lateral-view mirror assembly 10 coupled to rear portion of the vehicle 48 and located at a center portion 46 of the interior surface of the rear window 44 of the vehicle 48. The lateral view mirror assembly 10 is shown being used by a driver 42 to view cars lateral to the rear portion 51 of the vehicle 48. This is especially helpful when the driver 42 is changing lanes.

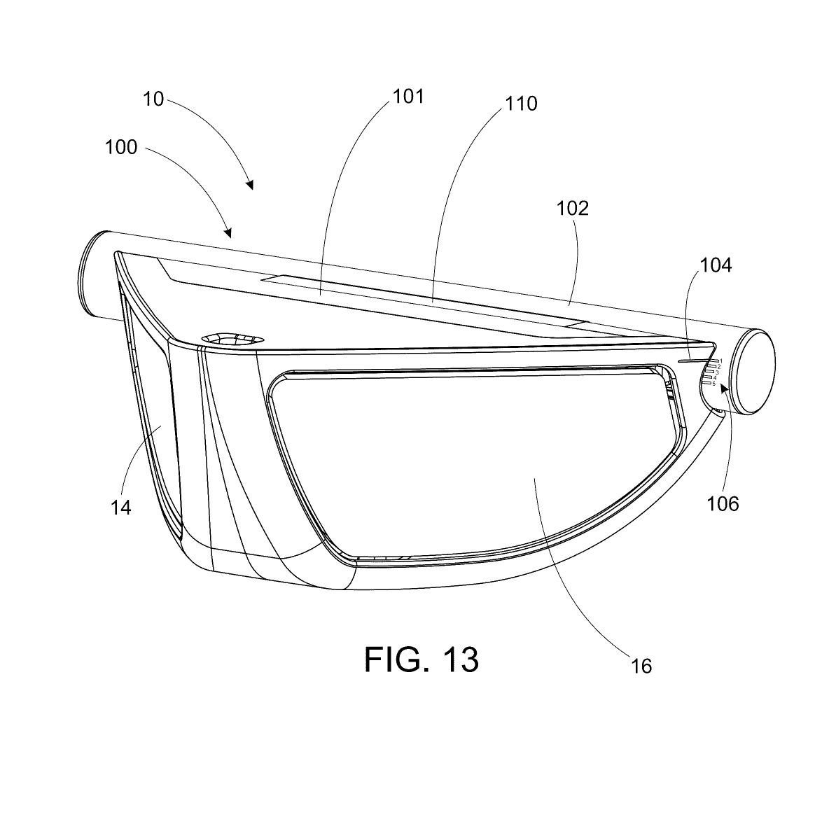

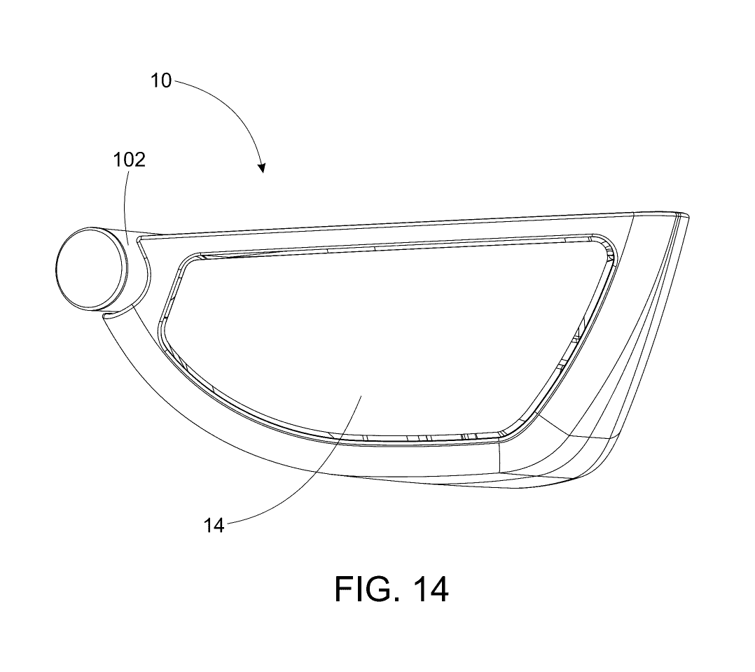

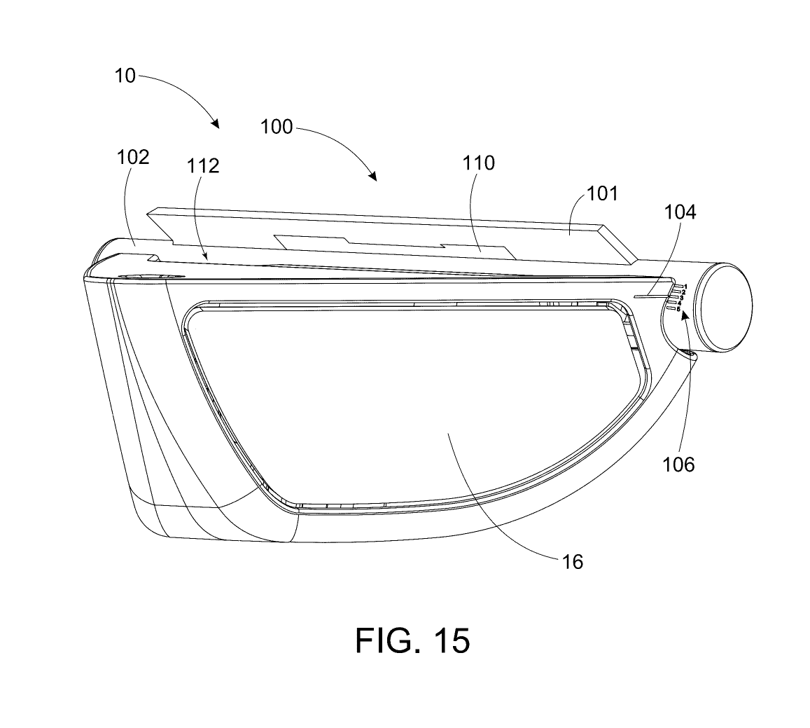

Referring again to the drawings, another embodiment of the lateral-view mirror assembly 10 is depicted in FIGS. 13-15. The lateral-view mirror assembly 10 may include housing 12 having a base 13, a first lateral-view mirror 14, and a second lateral-view mirror 16. The base 13 may be coupled to an adjustment device 100.

As described previously, the first lateral-view mirror 14 is coupled to the housing 12 and is positioned in line of sight with the rear-view mirror 40. The first lateral-view mirror 14 is dimensioned to allow a driver 42 (see FIG. 8) to view objects 54 (see FIG. 7) positioned lateral to a passenger's side 50 of a rear portion 51 of the vehicle 48 by reflecting the objects 54 from the first lateral-view mirror 14 to the rear-view mirror 40 to the driver 42.

Also, as described previously, the second lateral-view mirror 16 is also coupled to the housing 12 and is positioned in light of sight with the rear-view mirror 40. The second lateral-view mirror 16 is dimensioned to allow the driver 42 to view objects 56 (see FIG. 7) positioned lateral to a driver's side 52 of the rear portion 51 of the vehicle 48 by reflecting the objects 56 from the second lateral-view mirror 16 to the rear-view mirror 40 to the driver 42.

In embodiments, the adjustment device 100 may include an adjustment plate 101, a mounting plate 110, and a pivot structure 102. The adjustment plate 101 may be coupled to the base 13 by pivot structure 102. The housing 12 is then adjustable with respect to the adjustment plate 101 by rotation about the pivot structure 102. In some embodiments, the adjustment plate 101 may be coupled directly to the interior surface of the rear window 44 of the vehicle 48. The adjustment plate 101 may be coupled indirectly to the interior surface of the rear window 44 of the vehicle 48. In order to couple the adjustment plate 101 indirectly to the interior surface of the rear window 44, a mounting plate 110 may be coupled directly to the interior surface of the rear window 44 and the adjustment plate 101 may then be coupled directly to the mounting plate 110.

The pivot structure 102 may be a torque hinge, a friction hinge, or other type of hinge that may retain the housing at a user selected angle with respect to the adjustment plate 101. In some embodiments the pivot structure 102 allows for continuous adjustment of the angle and in other embodiments, the pivot structure 102 provides adjustment to discrete predetermined angles. The pivot structure 102 may also include an angle dial 106 that corresponds to an angle indicator 104 on the housing 12, wherein the angle indicator of the housing aligns with a particular angle value on the angle dial 106 to indicate the angle of the housing with respect to the adjustment plate 101. The angle value may be the actual angle value, or may be some other number indicator to indicate a particular position of the base 13 of the housing 12 with respect to the adjustment plate 101. The rotation of the base 13 with respect to the adjustment plate 101 operate to adjust the viewing angle of the first lateral-view mirror 14 and the second lateral-view mirror 16. This allows for a single embodiment of the lateral-view mirror assembly 10 to be used with various types of vehicles that each may have an angle of a rear window 44 that is different with respect to the surface of travel. In other words, the adjustment device 100 allows the lateral-view mirror assembly to be a universal lateral-view mirror assembly. Further still, the first lateral-view mirror 14 and the second lateral-view mirror 16 may be independently adjustable to provide further adjustment of the viewing ability of the mirrors 14 and 16. This adjustment may be powered or manual as previously described in other embodiments of the lateral-view mirror assembly 10.

The base 13 of the housing 12 may further include a recess 112, wherein the adjustment plate, and the mounting plate 102 may be received within the recess 112 when the base 13 is rotated adjacent the adjustment plate 101. In some embodiments, the recess 101 receives the adjustment plate 101 and the mounting plate 102 such that the base 13, the adjustment plate 101 and the mounting plate 102 form a single plane surface, thereby allowing flush mounting with a window 44.

Another embodiment may include a method of using a lateral-view mirror assembly for a vehicle. The method may comprise coupling the lateral-view mirror assembly to a rear portion of a vehicle to locate the housing at a substantially center portion of an interior surface-of a rear window; adjusting an angle of the lateral-view mirror assembly with respect to the rear window; using a first lateral-view mirror coupled to the housing, the first lateral-view mirror being positioned in a line of sight with a rear-view mirror of the vehicle to view objects positioned lateral to a passenger's side of the rear portion of said vehicle by looking at a reflection of the objects reflected from the first lateral-view mirror to the rear-view mirror to the driver; and using a second lateral-view mirror coupled to the housing, the second lateral-view mirror being positioned in a line of sight with the rear-view mirror of the vehicle, to view objects positioned lateral to the driver's side of the rear portion of the vehicle by looking at a reflection of the objects reflected from the second lateral-view mirror to the rear-view mirror to said driver.

In the method, adjusting the angle of the lateral-view mirror assembly with respect to the rear window comprises operating an adjustment device of the lateral-view mirror assembly to adjust the angle of the housing with respect to the rear window to adjust the viewing angle of the first lateral-view mirror and the second lateral view mirror. Further, the method may also include independently adjusting the first lateral-view mirror and the second lateral-view mirror within the housing.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A lateral-view mirror assembly for a vehicle comprising:
a housing coupled to a rear portion of a vehicle, wherein the housing is located at a substantially center portion of an interior surface-of a rear window and adjacent a ceiling of the vehicle to locate the housing above a head of a passenger seated below the housing;
a first lateral-view mirror coupled to the housing, the first lateral-view mirror being positioned in a line of sight with a rear-view mirror of the vehicle to allow a driver to view objects positioned lateral to a passenger's side of the rear portion of said vehicle by looking at a reflection of the objects reflected from the first lateral-view mirror to the rear-view mirror to the driver; and
a second lateral-view mirror coupled to the housing, the second lateral-view mirror being positioned in a line of sight with the rear-view mirror of the vehicle to allow the driver to view objects positioned lateral to the driver's side of the rear portion of the vehicle by looking at a reflection of the objects reflected from the second lateral-view mirror to the rear-view mirror to said driver.

2. The assembly of claim 1, further comprising lights coupled within the housing.

3. The assembly of claim 1, further comprising a compartment located within a base of the housing.

4. The assembly of claim 1, further comprising an integral brake light.

5. The assembly of claim 1, further comprising a backup camera to view objects positioned behind the rear portion of the vehicle.

6. The assembly of claim 1, wherein the housing is coupled to the interior surface of the rear window.

7. The assembly of claim 1, wherein housing is coupled to the ceiling of the vehicle.

8. The assembly of claim 1, further comprising rear lighting, wherein the rear lighting provides light behind and lateral to each side of the vehicle during backing operations.

9. A lateral-view mirror assembly for a vehicle comprising:
a housing moveably coupled to an adjustment device, wherein the adjustment device is coupled to a rear portion of a vehicle to locate the housing at a substantially center portion of an interior surface-of a rear window;
a first lateral-view mirror coupled to the housing, the first lateral-view mirror being positioned in a line of sight with a rear-view mirror of the vehicle to allow a driver to view objects positioned lateral to a passenger's side of the rear portion of said vehicle by looking at a reflection of the objects reflected from the first lateral-view mirror to the rear-view mirror to the driver; and
a second lateral-view mirror coupled to the housing, the second lateral-view mirror being positioned in a line of sight with the rear-view mirror of the vehicle to allow the driver to view objects positioned lateral to the driver's side of the rear portion of the vehicle by looking at a reflection of the objects reflected from the second lateral-view mirror to the rear-view mirror to said driver, wherein:
the adjustment device operates to adjust an angle of the housing with respect to the rear window to adjust the viewing angle of the first lateral-view mirror and the second lateral view mirror.

10. The assembly of claim 9, wherein the adjustment device couples the housing adjacent a ceiling of the vehicle to locate the housing above a head of a passenger seated below the housing.

11. The assembly of claim 1, further comprising a compartment located within a base of the housing.

12. The assembly of claim 9, wherein the adjustment device comprises an adjustment plate and a pivot structure.

13. The assembly of claim 12, wherein the pivot structure couples a base of the housing to the adjustment plate.

14. The assembly of claim 13, wherein the pivot structure operates to rotate the housing with respect to the adjustment plate.

15. The assembly of claim 14, wherein the adjustment plate is coupled to the interior surface of the rear window.

16. The assembly of claim 15, wherein the adjustment device further comprises a mounting plate, wherein the mounting plate is coupled to the interior surface of the rear window and the adjustment plate is coupled to the mounting plate.

17. The assembly of claim 12, wherein the pivot structure comprises a torque hinge.

18. A method of using a lateral-view mirror assembly for a vehicle, the method comprising:
adjustably coupling the lateral-view mirror assembly to a rear portion of a vehicle to locate the housing at a substantially center portion of an interior surface-of a rear window;
adjusting an angle of the lateral-view mirror assembly with respect to the rear window;
using a first lateral-view mirror coupled to the housing, the first lateral-view mirror being positioned in a line of sight with a rear-view mirror of the vehicle to view objects positioned lateral to a passenger's side of the rear portion of said vehicle by looking at a reflection of the objects reflected from the first lateral-view mirror to the rear-view mirror to the driver; and
using a second lateral-view mirror coupled to the housing, the second lateral-view mirror being positioned in a line of sight with the rear-view mirror of the vehicle, to view objects positioned lateral to the driver's side of the rear portion of the vehicle by looking at a reflection of the objects reflected from the second lateral-view mirror to the rear-view mirror to said driver.

19. The method of claim 18, wherein the adjusting the angle of the lateral-view mirror assembly with respect to the rear window comprises operating an adjustment device of the lateral-view mirror assembly to adjust the angle of the housing with respect to the rear window to adjust the viewing angle of the first lateral-view mirror and the second lateral view mirror.

20. The method of claim 18, further comprising independently adjusting the first lateral-view mirror and the second lateral-view mirror within the housing.
